(19) United States
(12) Patent Application Publication
(10) Pub. No.: US 2003/0139935 A1
(43) Pub. Date: Jul. 24, 2003

(54) Private property protection in public systems using smart card

(76) Inventor: Robert Roosevelt Silverman, Sunnyvale, CA (US)

Correspondence Address: Robert R. Silverman, M313, 655 S. FAIROAKS AVE, Sunnyvale, CA, 94086, US

(21) Appl. No.: 10/053,294

(22) Filed: Jan. 23, 2002

(51) Int. Cl. G06F 17/60

(52) U.S. Cl. 705/1

(57) ABSTRACT

In this application we describe a solution to the following problem. Consider publicly accessible shared machines such as washers and dryers in a public Laundromat or in a laundry room in an apartment building shared by the tenants of the building. The machines have the property that they are (1) publicly accessible by a large number of users and (2) while in use it is desirable that they should be only accessible by the user who started the machine. That is to say, the user who starts the machine wants to have its content protected from other users for the duration of the machine normal operation.

Currently, the protection consists of the user sitting in the Laundromat and waiting for the machine to complete its operation (for example the wash or dry).

We propose a mechanism that can be installed on such publicly accessible machine. The mechanism uses the smart card technology to lock the instrumented machine using a session key. A session key is a long string of bytes. Typical length might be between 64 bytes to 512 bytes. This number of bytes should become larger as the computational power of computers increases. So, for example, ten years from now, the number of bytes maybe need be 10 k bytes.

At the start of the machine operation, the user uses his/her smart card to lock the machine. At the end of the machine operation, the user uses his smart card to unlock the machine.

During the locking operation, the user will insert the smart card into the card acceptance device. This will start the operation of the logic decision circuit, which will generate a session key. The logic decision circuit will keep one copy of the session key, which will be stored in the instrumented machine, and the other copy of the session key will be stored in the smart card persistent memory.

For the unlocking operation, the user will insert the smart card into the card acceptance device and the logic circuit will read the smart card's session key. The logic circuit will perform compare operation of the session key in its persistent memory and the session key read from the smart card. If the keys match, then the logic circuit will unlock the instrumented machine.

### RELATED APPLICATIONS

None.

### FIELD OF INVENTION

The field of invention is an application of Smart Card technology to locking publicly accessible machines.

Keywords: Smart Card, session key, security, cryptography.

### PRIOR ART

The following technologies already exist individually and we have no invention claims on them.

We have no invention claims on: Smart Card with Memory only, Smart Card with CPU (microprocessor), Card Acceptance Device (CAD), major appliances such as washer, dryer, microwave oven, electronically controlled door, and random number generator.

I have not found any application of Smart Card technology to this type of problem searching on US PTO and on Delphion.com.

### LIST OF ADDITIONAL MATERIALS

None.

TERMINOLOGY

| term | description |
|---|---|
| SC | Smart Card. |
| | Two types of SC described below. |
| MSC | Memory Smart Card Device. |
| | Smart Card, which has persistent memory but no |
| | CPU. |
| CSC | CPU (Microprocessor) Smart Card Device. |
| | Smart Card, which contains microprocessor and |
| | persistent memory. |
| IM | Instrumented machine. |
| | A machine instrumented with the locking |
| | mechanism which details are discussed below. |
| | We will present multiple solutions to the problem. |
| Session | A set of related operations. |
| | In our case, a session is delimited by two |
| | operations: locking the instrumented machine at the |
| | start, and subsequent unlocking of the machine at |
| | the end. |
| SK | Session key. |
| | A string of bytes, which is randomly generated and |
| | is unique for this session. |
| SKSC | Session Key stored in Smart Card. |
| SKIM | Session Key stored in the instrumented machine. |
| LDC | Logic Decision Circuit. |
| | Logic circuit included in the instrumented machine. |
| MBS | Microprocessor Based System. |
| | Microprocessor Based System included in the |
| | instrumented machine. |
| | It is an alternate (programmable) implementation of |
| | LDC. |
| CAD | Card Acceptance Device. |
| | Equipment used to read and write smart cards. |
| ECD | Electrically controlled door. |
| | Machine door that can be locked and unlocked |
| | under the control of the Logic Decision Circuit. |

### THE PROBLEM

In this proposal we are solving the following problem. Consider a public machine that operates in a time-shared fashion on a private property. An example of such machine is a Laundromat or a laundry room in a building shared by the tenants in an apartment complex.

In this case the specific problem is this. We would like to protect the private property such as one person's clothing while it is being operated on by the instrumented machine (for example clothes are being washed) in a publicly accessible location.

### OVERVIEW OF THE INVENTION

Using the example of Laundromat as a domain of problem, the invention operates as follows. The user is equipped with a Smart Card (MSC). The washing machine is instrumented with the following subsystems, a (1) Card Acceptance Device (CAD), (2) a Logic Decision Circuit (LDC), (3) a Small Persistent Memory (SPM), and (4) an electrically controlled door (ECD). See figure below.

The LDC contains a hardware or software program to generate a session key (SK). The MSC will store the SK in its memory (as SKSC). Similarly, the LDC will store the SK (as SKIM) in its memory (SPM) and lock the door. Note that the SKSC is session key stored in MSC. Note that the SKIM is the same session key stored in the SPM of the instrumented machine.

Upon reinserting of the same MSC into the CAD, the LDC reads the SKSC from the MSC and compares the SKSC with its own SKIM from SPM. If there is match, the logic will open the door lock. Because the SK is very long string of bytes, it is hard to forge. This method guarantees that only the original person who inserted the clothes into the washer will be able to retrieve his clothes.

[image]

### DETAIL DESCRIPTION OF THE INVENTION

We will describe different solutions to the problem under discussion.

Solution 1

In this section we will describe the subsystems comprising the Solution 1.

Systems Comprising Solution 1:

The total system consists of two subsystems.

(1) Memory Smart Card (MSC) (carried by the user), contains memory only, no CPU.

(2) System attached to the instrumented machine (for example a washer or dryer).

The instrumented machine system consists of the following subsystems.

(2.1) Card Acceptance Device (CAD).

(2.2) A Logical Decision Circuit (LDC). Capabilities: generation of session key, comparison of two keys, lock door, unlock door.

(2.3) Small Persistent Memory (SPM).

(2.4) Electronically Controlled Door (ECD).

Operation of Solution 1

In this section we will describe the operation of the Solution 1 using pseudocode.

High-Level Operation of the System During Start Stage.

User selects an unused instrumented machine.

User loads the machine with his/her clothing for normal operation.

User inserts MSC into the instrumented machine CAD.

The LDC computes a session key (SKIM).

The LDC stores the SKIM in its persistent memory.

The LDC stores a copy of the session key SKSC in the smart card persistent memory.

(Note that the value of SKIM is identical to SKSC, but they are stored in different places.)

The LDC locks the door of the instrumented machine.

The user pushes proper start buttons of the instrumented machine.

The instrumented machine starts its normal operation.

(At this point, the user is free to leave the instrumented machine, since the door is safely locked.)

High-Level Operation of the System During Stop Stage.

The user returns to the instrumented machine.

The user inserts the MSC into the instrumented machine CAD.

The LDC reads the session key SKSC from the smart card.

The LDC reads its session key SKIM from its persistent memory.

The LDC compares the SKSC and SKIM for equality.

If the compare operation results in an equality, the LDC issues command to unlock the door.

The user removes the smart card from the CAD.

The user removes his/her possessions from the instrumented machine.

If the compare results in inequality, the door will remain locked.

Solution 2

In this section we will describe the subsystems comprising the Solution 2.

Systems Comprising Solution 2:

The total system consists of two subsystems.

1. Memory Smart Card (MSC) (carried by the user), contains memory only, no CPU.

2. System attached to the instrumented machine (for example a washer or dryer).

The instrumented machine system consists of the following subsystems.

(2.1) Card Acceptance Device (CAD).

(2.2) A Microprocessor Based System (MBS). Capabilities: generation of session key, comparison of two keys, lock door, unlock door.

(2.3) Small Persistent Memory (SPM).

(2.4) Electronically Controlled Door (ECD).

Operation of Solution 2

In this section we will describe the operation of the Solution 2 using pseudocode.

High-Level Operation of the System During Start Stage.

User selects an unused instrumented machine.

User loads the machine with his/her clothing for normal operation.

User inserts SC into the instrumented machine CAD.

The MBS computes a session key (SKIM).

The MBS stores the SKIM in its persistent memory.

The MBS stores a copy of the session key SKSC in the smart card persistent memory.

(Note that the value of SKIM is identical to SKSC, but they are stored in different places.)

The MBS locks the door of the instrumented machine.

The user pushes proper start buttons of the instrumented machine.

The instrumented machine starts its normal operation.

(At this point, the user is free to leave the instrumented machine, since the door is safely locked.)

High-Level Operation of the System During Stop Stage.

The user returns to the instrumented machine.

The user inserts the smart card into the instrumented machine CAD.

The MBS reads the session key SKSC from the smart card.

The MBS reads its session key SKIM from its persistent memory.

The MBS compares the SKSC and SKIM for equality.

If the compare operation results in an equality, the MBS issues command to unlock the door.

The user removes the smart card from the CAD.

The user removes his/her possessions from the instrumented machine.

If the compare results in inequality, the door will remain locked.

Solution 3

In this section we will describe the subsystems comprising the Solution 3.

Systems comprising Solution 3:

The total system consists of two subsystems.

(1) Microprocessor Smart Card (CSC) (carried by the user), contains microprocessor and persistent memory. Capabilities: generation of session key, comparison of two keys.

(2) System attached to the instrumented machine (for example a washer or dryer).

The instrumented machine system consists of the following subsystems.

(2.1) Card Acceptance Device (CAD).

(2.2) A Logical Decision Circuit (LDC). Capabilities: lock door, unlock door.

(2.3) Small Persistent Memory (SPM).

(2.4) Electronically Controlled Door (ECD).

Operation of Solution 3

In this section we will describe the operation of the Solution 3 using pseudocode.

High-Level Operation of the System During Start Stage.

User selects an unused instrumented machine.

User loads the machine with his/her clothing for normal operation.

User inserts CSC into the instrumented machine CAD.

The CSC computes a session key (SKSC).

The CSC stores the SKSC in its persistent memory.

The LDC stores a copy of the session key SKIM in the instrumented machine persistent memory.

(Note that the value of SKIM is identical to SKSC, but they are stored in different places.)

The CSC returns a code to the LDC to lock the door of the instrumented machine.

The user pushes proper start buttons of the instrumented machine.

The instrumented machine starts its normal operation.

(At this point, the user is free to leave the instrumented machine, since the door is safely locked.)

High-Level Operation of the System During Stop Stage.

The user returns to the instrumented machine.

The user inserts the CSC into the instrumented machine CAD.

The CSC reads the session key SKIM from the instrumented machine.

The CSC reads its session key SKSC from its persistent memory.

The CSC compares the SKSC and SKIM for equality.

If the compare operation results in equality, the CSC returns a code to the LDC to unlock the door.

The user removes the smart card from the CAD.

The user removes his/her possessions from the instrumented machine.

If the compare results in inequality, the door will remain locked.

We claim:

1:
(a) A system to enforce a Protection of Private Property in Public Systems Using Smart Card comprising of a system of: Memory Smart Card (MSC) and Instrumented Machine.
(b) The machine is instrumented with: Card Acceptance Device, Logic Decision Circuit, Small Persistent Memory, and Electronically lockable door.
(c) The LDC capability consists of operations: generation of session key, comparison of two keys, lock door, unlock door.

2:
(a) A system to enforce a Protection of Private Property in Public Systems Using Smart Card comprising of a system of: Memory Smart Card (MSC) and Instrumented Machine.
(b) The machine is instrumented with: Card Acceptance Device, Microprocessor Based System (MBS), Small Persistent Memory, and Electronically lockable door.
(c) The MBS capability consists of operations: generation of session key, comparison of two keys, lock door, unlock door.
(d) The MBS can be programmed in any of the following languages. It can be programmed in machine language, assembly, or any high level language (currently known or developed in the future) and compiled into executable code.

3:
(a) Same as claim 2.
(b) Same as claim 2.
(c) Same as claim 2.
(d) The MBS operates as follows. It runs KVM (a Java Virtual Machine for smart cards) or Java Micro Edition, or any future developed small footprint Java Virtual Machine and executes the application in Java byte codes.

4:
(a) A system to enforce a Protection of Private Property in Public Systems Using Smart Card comprising of a system of: Microprocessor Smart Card (CSC) and Instrumented Machine.
(b) The machine is instrumented with: Card Acceptance Device, Logic Decision Circuit, Small Persistent Memory, and Electronically lockable door.
(c) The CSC capability consists of operations: generation of session key, comparison of two keys.
(d) The LDC capability consists of operations: lock door, unlock door.
(e) The CSC operates as follows. It runs KVM (a Java Virtual Machine for smart cards) and executes a smart card application in Java byte codes
